(19) United States
(12) Patent Application Publication
(10) Pub. No.: US 2012/0089502 A1
(43) Pub. Date: Apr. 12, 2012

(54) METHOD AND SYSTEM FOR ROUTING IOI'S AND TRADE ORDERS

(76) Inventors: Adam E. Dix, Mountainside, NJ (US); Robert Warshaw, Pound Ridge, NY (US); Joseph Franchi, Westport, CT (US)

(21) Appl. No.: 13/271,690

(22) Filed: Oct. 12, 2011

Related U.S. Application Data
(60) Provisional application No. 61/392,332, filed on Oct. 12, 2010.

(51) Int. Cl. G06Q 40/04; H04L 9/32; H04L 9/00

(52) U.S. Cl. 705/37; 726/26

(57) ABSTRACT

Embodiments of the present invention include systems for linking routed orders to IOI's. Broker/dealers and buyside clients may be connected to the system through system interfaces or via standard FIX protocols. A broker/dealer may submit an order to the system, which verifies and forwards the order to an ATS to be matched with an authorized buyside order. The system constructs an actionable IOI (ATX-IOI) and sends the ATX-IOI to the buyside. The buyside may send responsive orders to the system, which verifies, creates, and submits a buy order to the ATS, preserving the anonymity of the buyside. If a trade is executed, the ATS delivers notice to the system, which may generate and send fill reports to the broker/dealer and buyside, at which point identifying information of the buyside may also be provided. The system may generate compliance and regulatory reports further to the completion of the trade.

### CROSS REFERENCE TO RELATED APPLICATION

This application claims priority to U.S. Provisional Patent Application No. 61/392,332, filed Oct. 12, 2010, entitled METHOD AND SYSTEM FOR ROUTING IOI'S AND TRADE ORDERS, the entire disclosure of which is incorporated herein by reference.

### BACKGROUND OF THE INVENTION

1. Field of the Invention

The embodiments of the present invention relate to systems and methods for trading financial instruments and, in particular, to computerized systems and methods of managing message traffic between buyside(s) and sellside(s). Embodiments of the present invention manage systems that govern the method by which parties to a trade are invited to a trading opportunity (e.g., a block-only trading opportunity) and provide for the protection of order related information and sharing of trade related information. The below-described exemplary embodiments of methods and order handling systems, which is also referred to by the applicant as “Autex LIVE™” or “AUTX™” facilitate efficiencies in the discovery of natural block liquidity between broker/dealers and their institutional clients.

2. Description of Related Art

Buyside traders are increasingly evaluating the cost/benefit of “low touch” business models to execute their block trades. Two examples of such models are: (1) buyside-to-buyside anonymous matching via an “Alternative Trading System” (ATS) and (2) the electronic channel “fragmenting” strategies, also referred to, collectively, as algorithmic trading strategies. Each model has inherent risks.

The first buyside-to-buyside model is subject to the risk of “adverse selection.” This risk is characterized by the perception of asymmetric information disclosure through the electronic negotiation process. The resulting risk is exemplified by a first party backing away from a trade prior to trade consummation, based on the belief that information the first party discloses during the negotiation process will lead the other party to back away and either pursue a better trade in a different execution channel or wait to execute at a later time. Either way, the concern of the first party is that its execution quality may be compromised and thus they may suffer the effect of a greater “market impact” due to this adverse selection.

In the second model, executing block orders in an algorithmic strategy, or low touch channel, presents at least two different types of risks to the buyside trader. The first is the time premium. Algorithmic strategies that fragment a single large block order into lots of small orders take time, and lack the immediacy of a natural block cross trade. The second risk is the market impact associated with information leakage, i.e. the disclosure of trading intentions through the use of an algorithmic strategy that poorly hides the buyside's trading intentions, block order details, and identifying information. Some algorithmic strategies (including “high frequency” proprietary strategies) are suspected of scanning the consolidated tape with the intent to decipher the “footprints” of a block order's executions while it's being parsed by its own chosen algorithm. This information can be used by others as the basis for opportunistically altering the high frequency trading strategy to the detriment of the buyside's block order execution quality. The low touch, or algorithmic, channel that includes high frequency and quant driven trading strategies does not afford the buyside trader absolute confidence in the prevention of information leakage.

Parties may not want to trade blocks in venues exposed to high frequency flows and should not be compelled to do so simply because of the prevailing belief that the industry's technological and regulatory evolution has driven the majority of other block trading opportunities into these fragmented channels.

Regardless of how a trade is completed, much of the buyside traders' efforts are motivated by the desire to minimize the risk of information leakage (e.g., without limitation, information relating to the trader's trading intentions, demand, price limits, quantity limits, block size, identities, etc.).

Buyside traders often prefer to execute “blocks” of stock with natural counterparts in an effort to minimize transparency of their trading intention to the broad market. The sellside cash equities desk is in the business of servicing the buyside desk for this purpose. However, current methods of communication between these desks requires the buyside client to disclose information relating to their trading intention (or information that could potentially be leaked) without the guaranteed satisfaction of receiving a trade execution, resulting in a risk of information leakage.

Currently, communication between a broker/dealer and their buyside client can be initiated in either direction. In the event a broker/dealer is representing one client's order to other clients, they indicate their trading interest in one of three ways: (1) via a pro-active phone call; (2) in an Instant Message (IM); or (3) as a “Natural” Indication of Interest. In all cases the responding buyside trader typically makes a phone call to the broker/dealer to negotiate terns that may differ by size or price depending upon the interest of the sell side respondent. The broker/dealer acts as an intermediary between these two potential counterparties as a facilitator to discovering the appropriate size@price which balances the two trading interests.

The nature of a phone call however, let alone a detailed discussion, is a time consuming inherent “leak” of the buyside traders intention prior to receiving satisfaction in the form of a trade execution. The responding buyside risks finding that their response was not first (liquidity traded away) or that satisfactory size@price trade discovery was unattainable at that time.

Further, the buyside's expectation of receiving a block trade satisfaction is in decline, due to a migration of block orders into the fragmenting, electronic channels of execution, collectively known as the ‘algorithmic’ channels, discussed above. The risk that the broker/dealer cannot execute, naturally, at least a portion of their trading interest is a rising deterrent to engaging the initiating broker/dealer.

Accordingly, it is desirable to provide a method and system for linking routed orders with indicated trading interests (also referred to herein as “Indications of Interest” or “IOI's”) such that buyside traders are given a measure of trade satisfaction prior to disclosing their full trading interest.

It is also desirable to provide a method and system for linking routed orders with IOI's such that the identities and trading intentions (e.g., trade offers, price limits, quantities demanded, etc.) of buyside traders are not disclosed before a trade is executed (and such information will not be disclosed if no trade is executed).

It is also desirable to provide a method and system for linking routed orders with indicated trading interests (e.g., IOI's) such that a broker/dealer's ownership of responsibility for clearing and settling their clients' trades is preserved such that the broker/dealer is not divested of its commission.

It is further desirable to provide a method and system for linking routed orders with indicated trading interests (e.g., IOI's) that results in faster, more efficient discovery of natural counterparties and improves the ratio of block crossed trades on the broker/dealer cash equities trading desk.

### SUMMARY OF THE INVENTION

Preferred embodiments of the present invention allow broker/dealer clients to anonymously engage broker/dealer liquidity in an Alternative Trading System (ATS).

In an exemplary embodiment, client orders are preferably allowed to interact with broker/dealer orders when invited to the interaction. In other embodiments, either party or any third party or an appropriate event may initiate an interaction. In further embodiments, the interactions may take place between several or more broker/dealers.

In an exemplary embodiment of a system in accordance with the present invention, the system includes a communications manager that is configured and arranged to receive and manage an actionable order from a sellside trader, such as a broker/dealer. Preferably, the broker/dealer commits to trade by entering the order, thus providing buyside traders, such as clients of the broker/dealers, with a guaranty of trade execution in the event of an order match.

In an exemplary embodiment, the system includes a web server. Preferably, the web server hosts a web accessible interface (e.g., a website) where a broker/dealer profile may be maintained and/or accessed. The profile may include without limitation details concerning a broker/dealer's orders, actionable IOI's, clients, preference of clients, client credit limits, client payment and clearance arrangements, order handling instructions, etc. A broker/dealer preferably can be provided with login/password access to the interface and create, set, monitor, and change its preferences and instructions. A broker/dealer may also preferably set default preferences and/or instructions via the interface.

In an exemplary embodiment, the broker/dealer profile and management data (e.g., without limitation client or trade data) may be maintained in a database.

In an exemplary embodiment, the system includes an internal database where administrative and/or management data, for example and without limitation, identification, login, and verification data may be stored.

In an exemplary embodiment, the system is capable of verifying identification information provided by the broker/dealer and buyside traders. In another exemplary embodiment, the system is capable of verifying orders and order information from the broker/dealer and/or client.

In an exemplary embodiment, the communications manager that is designed and configured to act as a single external “internalization engine” for multiple broker/dealers. The communications manager is preferably capable of managing the process of allowing broker/dealers to invite their own set of select clients to a trading opportunity via the creation and delivery of a uniquely “actionable” Indication of Interest (ATX-IOI).

In an exemplary embodiment, an ATX-IOI may preferably be derived from the attributes of an order sent to the system. In an exemplary embodiment, the communications manager is capable of creating an ATX-IOI based on data pertaining to an order sent by a broker/dealer. In another exemplary embodiment, the system can store general and default instructions pertinent to particular sellside traders, specific orders, the execution protocol, as well as the characteristics of a displayed ATX-IOI. It may also manage override instructions contained in the specific order used to generate the ATX-IOI.

In an exemplary embodiment, the system includes network accessible interfaces for the broker/dealer and the buy side traders to communicate with the system. In one embodiment, the system is capable of operating with Financial Information eXchange (FIX) protocol, as can be understood by one of ordinary skill in the art.

In an exemplary embodiment, the system may operate with existing Order and Execution Management Systems and can fit seamlessly within current workflows. For example, preferably, through a single FIX session connecting a buyside to the system, the buyside is able to trade with the liquidity of multiple broker dealers.

In an exemplary embodiment, an order from a broker/dealer is preferably transmitted to an ATS to await order execution. The order is preferably sent to a segregated execution engine on the ATS and trade execution is only permitted based on predetermined parameters (e.g., without limitation, client identity, validation of an authorization key, etc.). In one embodiment, the order may only be traded with an authorized contraparty. In another embodiment, authorized trading counterparties are preferably identifiable by an authorization key (or any other suitable type of identification verification tool or protocol). The authorization key may be transmitted to the buyside trader via a FIX message. In another embodiment, the system preferably prevents either parties' order to interact with any other order in the ATS.

In an exemplary embodiment, the system is capable of notifying buyside traders (e.g., clients of the broker/dealers) that the order may be traded (e.g. through the transmission of an ATX-IOI to clients). In an exemplary embodiment, the notification may be in the form of a FIX message sent to the selected clients of the broker/dealer. Exemplary embodiments of the system are capable of receiving responses and/or orders from the buyside traders. The system may also preferably receive and/or receive and verify the buyside traders' authorization key.

In an exemplary embodiment, the system builds a trade order based on order details received from a client. The system preferably sends the order to the ATS for order matching/execution.

In an exemplary embodiment, the system is capable of rejecting orders that do not meet regulatory or other predetermined requirements, for example and without limitation, block trade requirements. The system is preferably able to obtain the block size and/or monetary value of an order sent to the system from a broker/dealer. If the order does not meet block trade value and/or share size predetermined requirements (e.g., without limitation, 10,000 shares or $200,000 value), the order is rejected. In other embodiments, the system is preferably able to obtain the block size and/or monetary value of a client order. If the client order does not meet predetermined block trade value and/or share size requirements, it is rejected. In another embodiment, the system is capable of instructing the ATS to reject an order if such order does not meet predetermined block trade value and/or share size requirements. While block size and monetary value of an order is discussed here it can be appreciated by one of ordinary skill in the art that the system may be configured to reject orders based on any other parameter or requirement without departing from the scope of the present invention.

In an exemplary embodiment, the system receives a notification when an order match is made on the ATS (e.g., without limitation, price and quantity match). In another embodiment, the system receives a notification when an order is executed.

In an exemplary embodiment, the system preferably represents a single execution rules-set for broker/dealer presented liquidity, regardless of which broker/dealer the buyside engages. If no order match is made, the details of the client's order, including without limitation, the minimum/maximum price, minimum/maximum quantity, identity of the client, and the existence of the order and that any order was placed, is not disclosed to the broker/dealer or sellside trader. Even if an order match is made, the foregoing details may not be disclosed.

In an exemplary embodiment, in the event of a successful trading effort, the buyside's identity and trade details may be presented to the broker/dealer as an notice or alert (e.g., without limitation, in the form of a report or otherwise) to facilitate a post-trade phone negotiation or to facilitate the process of clearance and settlement. In other embodiments, the system is preferably capable of creating an execution report (or confirmation report) and transmitting notice of the order match to the broker/dealer. In one embodiment, the execution report preferably contains only the minimum amount of information required to facilitate trade clearance.

In an exemplary embodiment, the broker/dealer client order details preferably remain the responsibility of the system. In preferred embodiments, the system is configured and arranged to structure trade reporting such that the system manages information flows without being a party to the clearance and settlement responsibilities. In one embodiment, upon receipt of the execution report, the broker/dealer may step into the transaction to represent both the sellside and buyside on the ATS (and hence, not being divested of its commission on either side).

In an exemplary embodiment, the system is also capable of creating compliance reports. Preferably, the system is capable of producing, without limitation, Order Audit Trail System (OATS) compliance reports.

As a result of the ease of setup, the interaction confidence, and the information protections presented by the system, the buyside is more likely to respond. This likelihood will improve the broker/dealer use of their internal liquidity, resulting in a larger ratio of block orders “crossed” naturally, albeit externally, on the cash equities trading desk.

Additional features and advantages of embodiments of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE FIGURES

The foregoing summary, as well as the following detailed description of preferred embodiments of the application, will be better understood when read in conjunction with the appended drawings wherein like reference numerals refer to like components. For the purposes of illustrating the device of the present application, there is shown in the drawings preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices.

The drawings are not necessarily drawn to scale and are not in any way intended to limit the scope of this invention, but merely to clarify a single illustrated embodiment of the invention.

FIG. 1 is a network diagram of one or more exemplary embodiments of a system for linking routed orders with IOI's in accordance with the present invention.

FIG. 2 is a network diagram of the one or more exemplary embodiments of a system of FIG. 1 including additional details of the system 100.

FIG. 3 is a flow diagram illustrating one or more exemplary methods for linking routed orders with IOI's in accordance with the present invention.

### DESCRIPTION OF EXEMPLARY EMBODIMENTS

In accordance with various embodiments of the invention, and as shown in the drawings, various systems and methods, including computer-implemented methods, are disclosed which generally provide a method and system for handling IOI's and trade orders between buyside traders, e.g., clients, and sell side traders, e.g., broker/dealers. These embodiments are offered not to limit but to exemplify and teach the invention(s) and are shown and described in sufficient detail to enable those skilled in the art to make and use the invention(s). Thus, where appropriate to avoid obscuring the one or more inventions, the description may omit certain information known to those of skill in the relevant art.

As used herein, the term “computer” is intended to be construed broadly, and in a non-limiting manner, and to include, without limitation and by way of illustration only, any electronic device capable of receiving input, processing, storing and providing output, typically as digital data. A computer may be a computer of any style, size, and configuration including, without limitation, personal computers, servers, workstations, desktops, laptops, Internet appliances, notebooks, handheld devices such as PDAs and mobile smart phones (e.g., Blackberry®, iPhone®, iPad®, Treo®, and the like), or other wireless devices. Furthermore, in certain embodiments, user computers can be network systems having components such as servers, databases, etc. A computer typically includes the following components: a central processing unit (CPU or processor) operable in connection with software, permanent memory (e.g., hard-disk drive, ROM), temporary memory (e.g., RAM), an input device (e.g., keyboard, mouse, trackball, etc.), an output device (e.g., display), and I/O device (e.g., modem). It is known to persons skilled in the art that a computer may comprise some or all of those components, in addition to components not listed.

Various servers and other computer systems described herein include such art recognized components as are ordinarily found in server systems, including but not limited to processors, RAM, ROM, clocks, hardware drivers, associated storage, and the like. One skilled in the art will recognize, however, that because multiple users may be accessing such server at any given time it may become preferable to utilize multiple servers and databases, which may be used separately or in tandem to support the systems' traffic and processing, such as, by way of non-limiting example, a round-robin configuration utilizing multiple server systems.

Additionally, any steps of the inventive method, device, or part of the system described herein may be carried out or implemented in connection with a computer connectable to a network such as, for example, LAN, WAN, intranet, Internet (including the World-Wide Web), cellular, etc.

It should be further noted that although the embodiments described may use multiple software modules for performing the various functions of the system, other embodiments could be implemented using any number of modules, with any single module incorporating the functions of several, or all, of the modules. The precise design of the software and the programming language used may be designed differently within the scope of the present invention. The software modules can be created using art recognized programming languages, including but not limited to ASP, Java, C#, ASP.NET, or PHP or any combination of known programming languages that allow the functionality described.

It will also be understood that, although the various embodiments of the present invention described herein are being described in terms of web-based centralized server architecture, a thin client, fat-client, or peer-to-peer type arrangement could be substituted for the system architecture described herein and are within the scope of the present invention. Additionally, the programming described herein can be stored in a machine readable form on a computer readable medium, such as a CD-ROM or DVD, and distributed to users for installation on user computers. Alternatively, such programming can be downloaded via network. In either embodiment, communication with the system may be effected across known networks, such as the Internet.

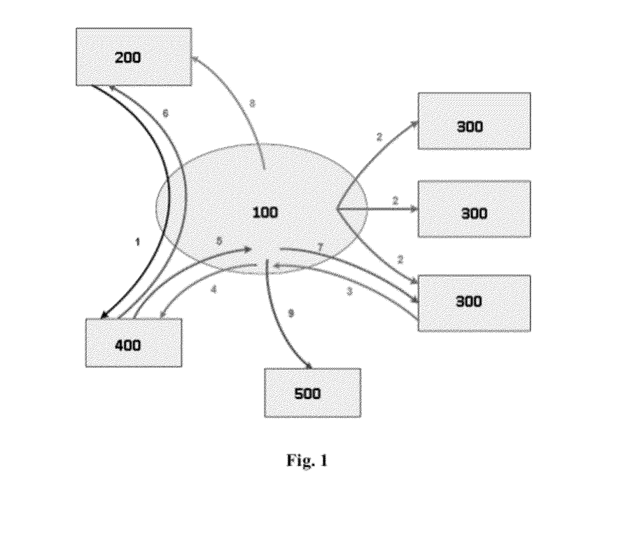

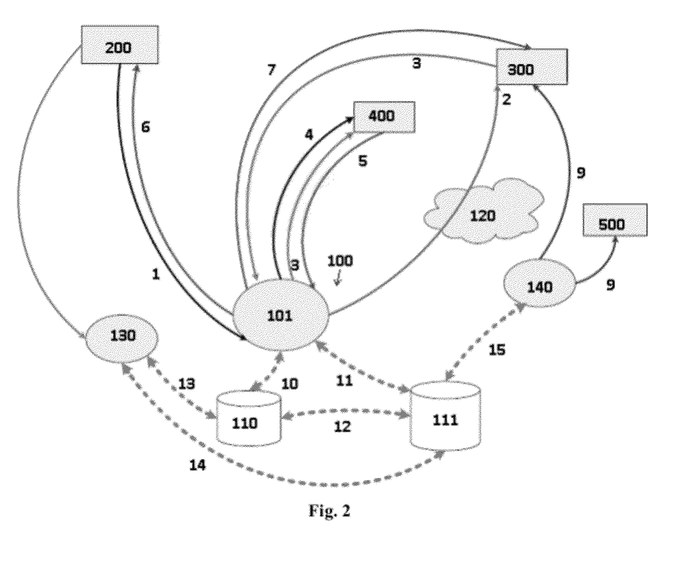

With reference to FIGS. 1-2, in one embodiment, a system 100 is provided. The system is preferably capable of governing the engagement of orders for the purpose of consummating a trade between sellside trader(s), such as broker/dealer 200, and buyside trader(s), such as a client 300 of the broker/dealer. As used herein, the respective parties will be referred to as the sellside, sellside trader, or broker/dealer (which may refer to the same entity or different entities or an agent of an entity on the sellside of a trade) on the one hand and the buyside, buyside trader, or client (which may refer to the same entity or different entities or an agent of an entity on the buyside of a trade) on the other hand, although one of ordinary skill could refer to the respective parties using other terms. One of ordinary skill in the art would appreciate that the terms “sellside” and “buyside” refer to the nature of the respective parties rather than the position a party assumes in a transaction. Nothing herein shall limit the type or position a party make take in a transaction. The system 100 preferably operates in connection with an ATS 400. As discussed further below, the system 100 may generate regulatory reports 140 as required by regulatory bodies, such as the Financial Industry Regulatory Authority (FINRA) 500.

With reference to FIGS. 1-2, in one embodiment, the broker/dealer 200 transmits an actionable order to the system 100, which transmits the broker/dealer's 200 order to an ATS 400, as indicated by path 1. The system 100 builds an actionable IOI (ATX-IOI) 120 based on the actionable order and transmits the ATX-IOI 120 to clients 300, as indicated by path 2. If a client 300 is interested in trading on an order, the system 100 receives a client order from the client 300, as indicated by path 3. The system 100 sends the client order to the ATS 400, as indicated by path 4. The ATS 400 determines whether there is a match between the actionable order and the client order. If there is an order match, the ATS 400 handles order execution and reports the execution to the system 100, as indicated by path 5. The system 100 creates a sellside execution report, providing only data necessary for trade clearance, including identifying information of the client 300 if necessary for clearance, and transmits the sellside execution report to the broker/dealer 200, as indicated by path 6. However, if a trade is not executed, no identifying information of the client 300 is disclosed. The system 100 may also generate a buyside execution report and transmit the buyside execution report to the client 300, as indicated by path 7. In another embodiment, the broker/dealer 200 may transmit an IOI to the system 100.

Once the execution report is delivered, the broker/dealer 200 may then clear and settle the trade with the ATS 400 on behalf of the sellside trader. The broker/dealer 200 also steps into the transaction on behalf of the client 300 (in place of system 100) and execute the trade on behalf of the client 300. The broker dealer 200 preferably also maintains responsibility for trade clearance with the client 300. The system 100 may generate compliance reports, such as OATS reports, to be sent to the regulatory authorities, such as FINRA 500, as indicated by path 9. The broker/dealer may also receive a trade notification (which may also be known as an orphan order to those of ordinary skill in the art) from the system 100, as indicated by path 8.

With reference to FIGS. 1-3, there is shown a flow diagram illustrating an exemplary method for linking a routed order to an ATX-IOI. First, the broker/dealer 200 sends an order to the system 100. The system 100 forwards the order to an ATS to await order matching at the ATS matching engine 410. Second, the system then creates an ATX-IOI 120 to be delivered to buyside client(s) 300. In this step, information pertaining to the ATX-IOI 120 may be displayed to the buyside client(s) 300. Third, an interested buyside client 300 may respond to the ATX-IOI 120 by sending a buyside order to the system 100. The system constructs a buy order based on the client's 300 buyside order and forwards the buy order to the ATS 400. The ATS matching engine 410 determines whether the buy order is a match to the order from the broker/dealer 200. If there is a match, the ATS 400 executes the order and notifies the system 100 of the trade. The system 100 may then send the broker/dealer 200 and the client 300 respective fill/execution reports to facilitate trade clearance between the broker/dealer 200 and client 300. The identity of the client 300 is not disclosed to the broker/dealer 200 until a trade is executed. In one embodiment, after trade execution, the identity of the client 300 may be included in the fill report transmitted to the broker/dealer 200 to facilitate trade clearance and further negotiation.

With reference to FIG. 2, the system 100 may include a Communications Manager (CM) 101 that may operate in connection with the ATS 400 and controls data flows in the system 100. The CM 101 may preferably control access to a block trading interaction, limiting access to only authorized parties. The CM 101 also preferably manages the information disclosures between broker/dealers 200 and their buyside clients 300. In another embodiment, the system 100 may serve as an ATS.

With reference to FIG. 2, the system 100 may include a web server 130, an internal database 110, and a client administrative database 111. The web server is in electronic communication with both the internal database 110 and client administrative database 111, as indicated by paths 13 and 14. The CM 101 is also preferably connected to the databases 110, 111, as indicated by paths 10 and 11. The databases 110, 111 are also connected to each other via a network, as indicated by path 12. These connections are preferably electronic network connections, but may include or constitute any other type of communicative connection presently known or later developed without deviating from the scope of the present invention.

The web server 130 preferably hosts a network accessible interface that providers broker/dealers 200 with access to a broker/dealer profile. In one embodiment, data relating to the broker/dealer profile may be stored in the client administrative database 111. The interface preferably permits the broker/dealer 200 to enter or modify profile data. This data may include, for example and without limitation, order information (such as trade symbols, quantity, and/or price), the nature of an order (e.g., buy, sell), limit price, credit limits, credit exemptions, trade clearance preferences, credit clearance preferences, payment options and/or preferences, and/or identities or name(s) and contact information of clients 300 that should receive an ATX-IOI 120. A broker/dealer 200 may also enter or modify additional instructions, for example and without limitation, to hide buy or sell opportunities from particular clients 300, the broker/dealer 200 can tier the importance of clients 300, and/or include payment and/or clearance instructions. Default settings may also be provided for any of the foregoing or for any other appropriate parameter. The system is preferably capable of storing such data (e.g., in databases 110, 111) and constructing, handling, verifying, and applying rules and directives relating to and/or associated with such data in linking trade orders. Additional parameters, instructions, and data may be entered by the broker/dealer 200 and managed by the system 100 without departing from the scope of the present invention.

In one embodiment, the interface may include a Setup Tool that preferably communicates a set of instructions to the CM 101. A broker/dealer 200 may designate an Administrator (which may be electronically provided in connection with a computer in one embodiment) to execute or oversee a variety of the functions. For example, the broker/dealer 200 may authorize an available client 300. Preferably, clients 300 are made available by enrolling for access to the system 100. Preferably, authorization confirms that a broker/dealer 200 has a pre-established trading relationship with the client 300 and, in the event the client 300 successfully responds to an ATX-IOI 120, the broker/dealer 200 is able to clear and settle the trade. The Administrator may also create and modify firm-level target list(s) comprised of some or all of the authorized buyside clients and designate a firm-level default target list when a unique system bound order does not include reference to a target list. The Administrator may also preferably designate other firm-level default message instructions. The Administrator may also designate a rule that will allow the system 100 to accept SELL SHORT orders from responding clients 300 in response to a broker/dealer 200 BUY order (in on embodiment, absent this rule, the system 100 will reject SELL SHORT orders). Any or all of the foregoing may be controlled via the Setup Tool. Additional or different parameters may also be entered and/or managed with the Setup Tool without deviating from the scope of the present invention.

With reference to FIGS. 1-2, in one embodiment, the lifecycle of an IOI preferably begins with the broker/dealer 200 routing an order to the system 100, including actionable trade order data. Trade order data may include, for example and without limitation, ticker symbols, quantity, price, whether the actionable order is for a buy or sell position, high/low limit price, and the identities of buyside clients 300 or target lists of buyside clients 300 authorized to receive an actionable IOI.

Preferably, the CM 101 may generate an ATX-IOI 120 on behalf of the broker/dealer 200 based on the order and/or order data received from the broker/dealer 200. The ATX-IOI 120 is preferably constructed based upon the attributes of the actionable order and/or order data submitted to the system 100 (e.g., as discussed above).

The system 100 receives the order from the broker/dealer 200 and preferably performs verification protocols based on the information provided and/or the information stored in broker/dealer's 200 profile (e.g., in the client administrative database 111 or the internal database 110 or any other database connected to the system 100). These verification protocols check the integrity of an actionable order and prepare the order for transmission to an ATS 400 and an ATX-IOI 120 to buyside clients 300.

In an exemplary embodiment, this verification process can be handled by the CM 101. In exemplary embodiments, the CM 101 is capable of verifying that the broker/dealer 200 is approved to access the system 100. The CM 101 may also confirm that any order FIX tags conform to predetermined rules of the system 100. The CM 101 may also confirm that a target list containing at least one authorized client 300 is either attached to the order or referenced by default. The CM 101 may further be capable of increasing the minimum size of an order provided by a broker/dealer 200 such that a resulting execution will comply with FINRA's definition of “block” size in order to preserve the right to preferentially present an ATX-IOI 120 to a select audience. Additionally, the CM 101 may convert the order's TimeInForce (a parameter that defines the duration of a trade ticket) to match the execution protocol's defined trading window. The CM 101 is preferably also capable of creating matching ReferenceID's and tagging the order from the broker/dealer 200 prior to delivering the order to the ATS 400 and also tagging the consequent ATX-IOI 120 prior to distributing it to the targeted client(s) 300 with the matching ReferenceID's. The ReferenceID's can be used for verification and identification purposes. The CM 101 may be used to perform any combination of the foregoing functions or any additional functions relating to order verification and management without deviating from the scope of the present invention.

In an exemplary embodiment, the CM 101 also manages delivery of the order to an ATS 400 (for example, the Level ATS). Preferably, the ATS 400 is instructed to handle an order with a segregated execution engine on the ATS 400 to prevent unauthorized buyside firms from trading on an ATX-IOI and/or to prevent execution of unauthorized orders (e.g., from authorized buyfirms). In this regard, the system 100, either through the CM 101 or any other communicative connection, may instruct the ATS 400 to only permit a trade with an authorized counter-party. An authorized counterparty may be identified with an authorization key or reference ID (e.g., the ReferenceID discussed above) provided by the system 100. In other embodiments, trading with respect to the ATX-IOI may be otherwise limited to authorized clients 300 by any other means presently known or later developed.

With reference to FIG. 2, in an exemplary embodiment, the system 100, after receiving an order and/or actionable trade order information from a broker/dealer 200, the system 100 constructs a corresponding ATX-IOI 120 based on the order and/or actionable trade order information and/or a broker/dealer's 200 profile and instructions (e.g., those discussed above).

In one exemplary embodiment, the CM 101 preferably delivers the ATX-IOI 120 to the broker/dealer target list of clients 300. The system 100 may cause the ATX-IOI 120 to display on the client's 300 front end display, or when established, on the FIX-IOI display module embedded within the trader's OMS or EMS (other “display mechanisms”). In another embodiment, the ATX-IOI 120 may be caused to be displayed on any other appropriate viewer without deviating from the scope of the present invention.

In one embodiment, selected information pertaining to the ATX-IOI is caused to be displayed to clients 300. Preferably, the displayed interface includes display exceptions relative to other IOI's (e.g., non-actionable yet “Natural” IOI's), as can be understood by one of ordinary skill in the art. For example, the broker/dealer displayed Sender acronym is preferably eight characters maximum, formatted: ATX<underscore>MPID (Market Participant Identifier) (e.g., “ATX_DLRX”). Preferably, no price is displayed. The nature of the ATX-IOI (e.g. the side) may or may not be displayed, preferably based on the sending broker/dealer's 200 discretion. Furthermore, the “Valid Until” time is represented as a countdown clock when supported by the display mechanism. Also, in one embodiment, when supported by the display mechanism, the ATX-IOI is colored yellow, and remains on top of all other Natural IOI's until expiration. Moreover, in embodiments where a ReferenceID is required, the ReferenceID required in a buyside responsive order is preferably displayed in the Comments (or Notes) field, but may be displayed in another appropriate location or provided by any other appropriate means.

In one embodiment, all broker/dealer authorized client(s) 300 that are targeted with a particular ATX-IOI 120 are permitted to engage that broker/dealer liquidity via the system 100. An interested client 300 who desires to engage in the liquidity may transmit a responsive order to the system 100 within the permitted time period (as can be specified as part of the ATX-IOI 120). The buyside order may include the ReferenceID in a predetermined location, for example and without limitation a FIX tag location (e.g., FIX tag 23 or 58). The buyside order is preferably otherwise compliant with supported order attributes. In another embodiment, a ReferenceID may not be required. In another embodiment, another type of suitable identifier may be used without deviating from the scope of the present invention. In yet another embodiment, the selected identifier may be stored in any suitable location.

The system 100 may receive the responsive order from client 300 and is preferably capable of controlling the interaction of the buyside order with any other orders in the system 100. In one embodiment, if the initiating broker/dealer order has not expired, the system 100 may confirm that (1) the client 300 is responding with a contra-order in the same symbol, (2) the client 300 is authorized to do so, and (3) the client 300 is a client targeted by the broker/dealer with respect to the particular ATX-IOI (which can be done using the ReferenceID associated with the ATX-IOI or any other type of identifier, as appropriate). In one embodiment, the system 100 is capable of confirming these conditions (or others without limitation) are met and delivers the buyside order to the ATS 400 to be compared with the broker/dealer order. In another embodiment, the system 100 constructs a system buy order based on the client order and/or information about the client 300 stored in the broker dealer profile (e.g., on database 111) for delivery to the ATS 400. In this manner, the client 300 may remain anonymous as the identity of the client 300 is preferably not disclosed prior to order execution (as further discussed below).

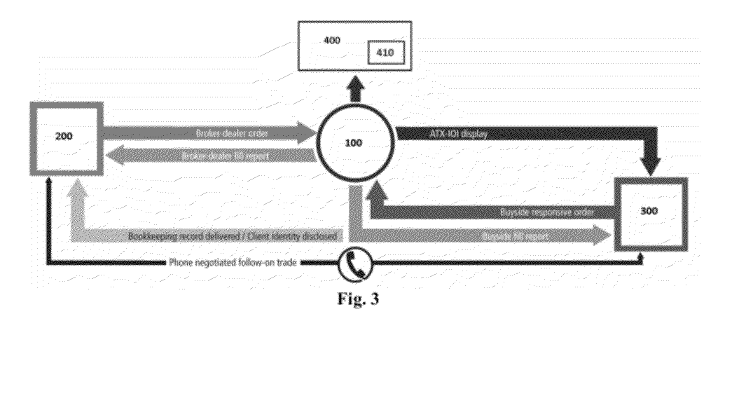

The ATS matching engine 410 (see FIG. 3) may preferably apply predetermined matching rules to the two orders to determine whether there is a match. In one embodiment, the ATS 400 preferably maintains responsibility for trade matching and execution. In another embodiment, the system 100 may serve as an ATS and is preferably capable of comparing the buyside order with the broker/dealer order.

In one embodiment, the system 100 may be used to verify that orders comply with block size/value requirements as set forth by regulatory authorities to preserve the right to present the ATX-IOI's to select buyside clients 300. The system 100 may be configured to obtain and analyze the block size and share value associated with trade order(s) submitted by a broker/dealer 200 and reject any orders that do not meet legal block minimum requirements. The system 100 may do so by receiving the block size and/or value from the broker/dealer 200 or by ascertaining the block/size and/or value based on the trade order data, the broker/dealer's 200 profile, or any other available and applicable data. If the trade order does not meet block trade value and/or share size predetermined requirements (e.g., without limitation, 10,000 shares or $200,000 value), the trade order is rejected. The system 100 is preferably also capable of obtaining or receiving the block size and/or monetary value of shares in connection with a buyside client order. If the buyside order does not meet predetermined block trade value and/or share size requirements, the client order is also rejected. The system 100 may also provide instructions to the ATS 400 to reject an order (either or both buyside and sellside orders) if such order does not meet predetermined block trade value and/or share size requirements. While block size and monetary value of an order is discussed here, the system may be configured to reject orders based on any other parameter or requirement without departing from the scope of the present invention.

In exemplary embodiments, the identity of the buyside 300 and any details concerning a buyside order (including the existence of the buyside order) is known only to the system 100 (other than the disclosing party). This information is not disclosed to the broker/dealer 200, ATS 400, or any other party until a trade has been executed, except as required by applicable law, rule, and/or regulation. In this manner, in the event that no trade is executed, the buyside 300 remains anonymous and the buyside order information and buyside's effort to trade are not disclosed to the broker/dealer 200. Accordingly, the present system prevents the leakage of information from the client 300 that could be used against the client's 300 trading interests.

Furthermore, even in the event that an order match is made, information concerning the client 300 and buyside order is preferably not completely forwarded to the broker/dealer 200. In a preferred embodiment, the broker/dealer 200 only receives sufficient information to clear the trade with the client 300. The necessary information may be provided to the broker/dealer 200 by the system 100 in an execution report, as discussed below.

With regard to the trade between the system 100 and the ATS 400, after an order is executed, the broker/dealer 200 steps into the position of the system 100 for purposes of trade clearance. In one embodiment, the system 100 may generate and deliver execution (or fill) reports to both parties to the trade 200, 300 to facilitate trade clearance. The execution report transmitted to the broker/dealer 200 preferably contains the identity of the responding client 300 and any other particulars necessary to facilitate trade clearance between the broker/dealer 200 and the client 300. Notably, in preferred embodiments, only at this point, post-trade execution, is the identity of the client 300 disclosed to the broker/dealer 200 to prevent unwanted information leakage and to mitigate hostile trading interests to the client 300. The buyside fill report preferably contains the identity of the originating broker/dealer 200 and any other details provided by the broker/dealer 200 and/or the system 100.

The system 100 is preferably capable of generating compliance reports 140 and handling compliance reporting (e.g., without limitation, OATS reports as required by FINRA 500; see also path 9). In one embodiment, for regulatory purposes, when the system 100 receives a buyside order from the client 300 (e.g., path 3), it preferably assumes all record-keeping and reporting responsibilities for such buyside order. In the event of a trade, the system 100 may discharge certain regulatory obligations through the broker/dealer 200 based on predetermined contractual and/or operational arrangements.

Embodiments of the system 100, such as those described above, add value to both participants as a new electronic trade channel. For the client 300, the initial disclosure of its trading intentions to a broker/dealer 200 is no longer a concern as the client 300 remains anonymous at least until a trade is executed. This “anonymity unless a trade occurs” feature of embodiments of the system 100 allows the client 300 to freely respond to a broker/dealer's 200 invitation via the system 100 without the adverse consequence of unrewarded information leakage. Thus, the client 300 has an equal role in defining terms that constitute the “discovery” trade.

Moreover, the present system and method gives the client 300 confidence that a trade may be executed if orders are matched (i.e., to mitigate concerns that a broker/dealer 200 is simply fishing for market information) because the submission of an order by the broker/dealer constitutes a representation that the broker/dealer 200 is committed to trade. Thus, the buyside may receive an initial trade satisfaction prior to disclosing their full trading interest. This process filters out trading overtures that are not at least minimally aligned. Accordingly, exemplary embodiments of the systems and methods of the present invention facilitate a faster, more efficient discovery of natural counterparties.

Exemplary embodiments of the present invention also re-invigorate the expectation that a block may find a natural counterpart. Embodiments of the present invention benefit the broker/dealer 200 as they maintain their responsibility for clearing and settling their client's trade and, hence, they are not disintermediated from the commission collected during this process. Further, upon execution, embodiments of the present invention may inform the broker/dealer cash equity desk of the responding client's identity. Thus, the broker/dealer's 200 role as intermediate negotiator between two discovered counterparties on the potentially larger block cross trade may be preserved as well. Embodiments of the present invention not only respond to disintermediating competitive threats, but also preserves the role of “relationship” and dual commission economics core to the value of executing a block cross trade while servicing buyside clients 300.

Furthermore, embodiments of the present invention improve the ratio of block crossed trades on the broker/dealer cash equities trading desk, and improves the expectation that a block order's natural counterpart will be discovered in a timely manner. As such, embodiments of the present invention facilitate reversing the current trend of block order fragmentation.

One having ordinary skill in the art will recognize that the various methods and systems described for the preferred embodiments of the present invention may be adapted and interchanged between the preferred embodiments, without significantly impacting the present invention. Those skilled in the art will recognize that the present invention has many applications, may be implemented in many manners and, as such is not to be limited by the foregoing embodiments and examples. Any number of the features of the different embodiments described herein may be combined into one single embodiment, particular elements may be altered and alternate embodiments having fewer than or more than all of the features herein described are possible. Functionality may also be, in whole or in part, distributed among multiple components, in manners now known or to become known.

It will also be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention, including buyside-initiated and broker/dealer-to-broker/dealer systems and configurations. While there had been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A computerized system for linking one or more actionable orders transmitted over an electronic network, the system comprising:
a communications manager, wherein the communications manager is arranged and configured to:
receive the one or more actionable orders;
cause the transmission of one or more sellside orders based on the one or more actionable orders via the electronic network;
create one or more IOI's corresponding to the one or more actionable orders;
cause the transmission of the one or more IOI's;
receive one or more orders in response to the one or more IOI's; and
transmit one or more buyside orders based on the one or more received orders via the electronic network for fulfillment, wherein the communications manager is configured and arranged to retain the anonymity of the one or more orders and the source of the one or more orders until the one or more buyside orders are filled.

2. The system of claim 1 wherein:
the one or more actionable orders are transmitted from one or more sellers via the electronic network;
the one or more orders are transmitted from one or more buyers via the electronic network; and
the communications manager is further arranged and configured to:
receive seller identifying data;
receive buyer identifying data;
verify the identity of the one or more sellers based on the seller identifying data; and
verify the identity of the one or more buyers based on the buyer identifying data.

3. The system of claim 1 wherein the one or more sellside orders is the one or more actionable orders.

4. The system of claim 1 wherein the communications manager is further arranged and configured to:
receive one or more fulfillment notifications;
generate one or more execution reports based on the one or more fulfillment notifications; and
transmit the one or more execution reports to one or more selected recipients.

5. The system of claim 1 wherein the communications manager is further arranged and configured to:
create one or more authorization keys;
associate the one or more authorization keys with the one or more actionable orders;
associate the one or more authorization keys with the one or more corresponding IOI's;
transmit the one or more authorization keys in connection with the one or more buyside orders.

6. The system of claim 1 wherein the communications manager is further arranged and configured to:
obtain a block size of the one or more actionable orders;
obtain a monetary value of the one or more actionable orders;
analyze the block size and monetary value of each actionable order based on predetermined requirements; and
reject the actionable order if the block size and monetary value do not meet the predetermined requirements.

7. The system of claim 1 wherein the communications manager is further arranged and configured to:
obtain a block size of the one or more orders;
obtain a monetary value of the one or more orders;
analyze the block size and monetary value of each order based on predetermined requirements; and
reject the order if the block size and monetary value of do not meet the predetermined requirements.

8. The system of claim 1 wherein the communications manager is further arranged and configured to:
instruct the trading system to reject the one or more buyside orders if a block size and a monetary value associated with the one or more buyside orders does not meet predetermined requirements.

9. The system of claim 1 wherein the communications manager is further arranged and configured to
generate one or more compliance reports; and
transmit the one or more compliance reports to a regulatory agency.

10. The system of claim 1 further comprising a web server arranged and configured to generate a control interface, the control interface arranged and configured to permit a sellside to enter and modify one or more sellside parameters.

11. The system of claim 10 wherein at least one of the sell side parameters is selected from the group consisting of authorized client identities, authorized client contact information, client credit limits, credit clearance preferences, hide buy instructions, hide sell instructions, accepted payment methods, payment instructions, trade clearance settings, client tier preferences, default parameters.

12. The system of claim 1 further comprising an at least one administrative database for storing one or more sellside profiles.

13. The system of claim 2 further comprising at least one internal database for storing buyer identifying data and seller identifying data.

14. The system of claim 1 wherein the communications manager is configured and arranged to operate in conjunction with one or more FIX protocols.

15. A computerized system for managing data to minimize the risk of information leakage, the system comprising:
a manager component, wherein the manager component is arranged and configured to:
receive actionable order data;
cause the transmission of a sellside order based on the actionable order data for execution in accordance with predetermined segregated execution specifications;
cause the transmission of an IOI;
receive buyside data relating to the IOI;
cause the transmission of a buyside order based on the buyside data for fulfillment, wherein the manager component is configured and arranged to retain the anonymity of the buyside data and the buyside order until the buyside order is executed.

16. A computer readable medium having computer readable program code thereon for execution by one or more computer processors for performing a method comprising:
receiving trade data relating to one or more actionable orders;
causing transmission of one or more sellside orders based on the trade data;
causing transmission of one or more IOI's relating to the trade data;
receiving IOI data relating to the one or more IOI's; and
causing transmission of one or more buyside orders based on the IOI data, wherein the anonymity of the one or more buyside orders and IOI data is preserved until the one or more buyside orders are fulfilled.

17. The computer readable medium of claim 16 wherein the trade data is transmitted by one or more sellers and the IOI data is transmitted by one or more buyers and the method further comprises:
receiving seller identifying data;
receiving buyer identifying data;
verifying the identity of the one or more sellers based on the seller identifying data; and
verifying the identity of the one or more buyers based on the buyer identifying data.

18. The computer readable medium of claim 16 wherein the method further comprises:
receiving one or more fulfillment notifications from the trading system;
causing generation of one or more execution reports based on the one or more fulfillment notifications; and
causing transmission of the one or more execution reports to one or more selected recipients.

19. The computer readable medium of claim 16 wherein the method further comprises:
creating one or more authorization keys;
associating the one or more authorization keys with the trade data;
causing transmission of the one or more authorization keys in connection with the one or more sellside orders; and
causing transmission of the one or more authorization keys in connection with the one or more IOI's.

20. The computer readable medium of claim 16 wherein the method further comprises:
generating one or more compliance reports.
